(19) United States
(12) Patent Application Publication
(10) Pub. No.: US 2010/0068457 A1
(43) Pub. Date: Mar. 18, 2010

(54) BIOCIDAL/HYDROPHOBIC INNER COATING OF CONDENSER PIPES (OF INDUSTRIAL TURBINES AND SUBSIDIARY COOLING CYCLES)

(76) Inventors: Anke Soellner, Bubenreuth (DE); Heinrich Zeininger, Obermichelbach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/595,564

(22) PCT Filed: Apr. 10, 2008
(86) PCT No.: PCT/EP2008/054326

§ 371 Date: Oct. 12, 2009

(30) Foreign Application Priority Data
Apr. 13, 2007 (DE) 10 2007 017 518.5

(51) Int. Cl. B32B 3/00; B32B 5/00; B32B 5/02; B05D 3/06; B05D 7/22; B05D 3/02; C09D 5/16; H01B 1/22; C09D 5/14

(52) U.S. Cl. 428/141; 428/220; 428/338; 427/553; 427/230; 427/236; 523/122; 252/519.21; 106/15.05

(57) ABSTRACT

A coating for containers and pipes of, for example, metal, glass, plastic, or ceramic, particularly for condenser pipes, for reducing or avoiding the formation of a biofilm is provided. Further, a method for producing the coating is provided.

### CROSS REFERENCE TO RELATED APPLICATIONS

This application is the US National Stage of International Application No. PCT/EP2008/054326 filed Apr. 10, 2008, and claims the benefit thereof. The International Application claims the benefits of German Application No. 10 2007 017 518.5 DE filed Apr. 13, 2007; both of the applications are incorporated by reference herein in their entirety.

### FIELD OF INVENTION

The present invention relates to a coating for containers and pipes made, for example, from metal, glass, plastics or ceramic material, in particular condenser pipes, for reducing or preventing biofilm formation, and a method for manufacturing the coating.

### BACKGROUND OF INVENTION

Due to the fact that there are optimum temperatures for organisms, it is possible that, for example, in condenser pipes of industrial turbines and other heat exchangers, biofilms and algal growth known as ‘biofouling’ can form.

A biofilm is a permanent protective habitat for microorganisms (e.g. bacteria, algae, fungi, protozoa). Biofilms form mainly in aqueous systems when microorganisms colonize boundary surfaces, for example, the boundary surface to a solid phase. Apart from the microorganisms, the biofilm contains mainly water. Extracellular polymer substances (EPS) excreted by the microorganisms combine with water to form hydrogels, so that a slimy matrix, the glycocalyx is produced, giving the biofilm a stable structure and enabling the microorganisms to hold firmly to all materials and tissues. The glycocalyx consists of biopolymers. A wide spectrum of polysaccharides, proteins, lipids and nucleic acids is involved herein.

The glycocalyx protects the bacteria against environmental influences such as temperature changes, flow rates, etc. The bacteria are supplied with oxygen and nutrients through water channels of the glycocalyx. The sorption properties of the glycocalyx result in an accumulation of nutrients and this is therefore part of the survival strategy of biofilm organisms in oligotrophic environments.

At the boundary layer to water, cells or whole sections of the biofilm can be repeatedly released and taken up by the water flowing past. The biofilms themselves filter arriving new cells and bacteria and decide whether a particle arriving from outside is permitted to remain or is repelled. For this intercellular communication necessary for the differentiation of the biofilm, also known as ‘cell-to-cell signaling’, suitable messenger substances or signal molecules are emitted.

The highest purpose of this information exchange is the regulation of gene expression, which ultimately enables the ordered formation of the biofilm system. This intercellular information exchange is essentially based on the continuous release of messenger substances in low concentrations by the bacterial cells. This principle of cell density-dependent regulation of gene expression is designated ‘quorum sensing’. This involves an intercellular and intracellular communication and regulation system using signal molecules, the ‘autoinducers’. The system enables the cells of a suspension to measure the cell density of the population and to react thereto through autoinduction. Depending on the cell density, the concentration of the signal molecules in the ambient medium rises and, once a critical threshold concentration has been exceeded, induces the transcription of specific gene products in the bacterial cells, leading to targeted changes in the phenotypic functions of the microorganism.

Industrial process water or processing water systems, for example, open or closed water circuits, water processing systems and service water systems or cooling water systems offer suitable conditions for the multiplication of microorganisms. The biofilm leads to changes in the physicochemical properties of the material in question, e.g. with regard to its frictional resistance, diffusion properties or thermal conductivity. In addition, the excretions from the biofilm organisms can accelerate the corrosion of their substrate, a process known as ‘biocorrosion’. Biocorrosion essentially causes changes in the structure and stability of a material through aesthetically impairing discoloration, the excretion of directly or indirectly corrosive metabolic products, right through to enzymatic decomposition of the materials in question.

A wide variety of damage can be produced as a consequence of biofouling and biocorrosion, such as increased resistance to thermal conduction and, associated therewith, raised condenser pressure, worsening of water quality, safety problems, e.g. through blocking of valves, increased cleaning costs, breakdown times, loading of plant parts due to cleaning procedures, reduced plant output, shortened service lifetimes, reduced cooling performance with a grater energy consumption and increased use of biocides and cleaning agents, and therefore increased waste water pollution.

A variety of methods have been developed to prevent or delay the formation of biofilms or to remove them. These include mechanical destruction of the biofilms, measures for disinfection and germ removal from the water and enzymatic methods for removing biofilms.

In order to prevent or clear away deposits, pipe cleaning systems, such as the Taprogge system, are used, wherein sponge rubber balls are fed through the plant in the circuit together with the cooling water. These systems are very expensive and are seldom used in relatively small condensers such as industrial turbines and subsidiary circuits. Other conventional methods for preventing biofouling are, for example, a pipeline design which leads to a flow rate of 2-3 m/s, a two-part condenser design, a two-stranded pipe cleaning system, condenser back-flushing and thermal treatment.

The deposition of bacterial slimes can be effectively controlled with biocides, although the biofilm affords a certain degree of protection to the microorganisms. Therefore, very high concentrations of biocides are required to kill off the bacteria, and this is undesirable for reasons of environmental protection. Microorganisms are also particularly difficult to remove from the biofilms. In order to prevent formation of the biofilm, biocides such as sodium hypochlorite and chlorine dioxide are currently used.

Metals such as copper, aluminum and zinc and possibly also silver are toxic to bacteria. For example, the Cuprion anti-fouling system uses copper and aluminum anodes in an insulated steel frame which serves as a cathode. Herein, soluble biocides in the form of copper ions and aluminum ions are released into the cooling water.

DE 102 25 324 A1 uses an antimicrobial (acryl) paint with nanoparticles that are smaller than 100 nm, the surfaces of which are enriched with silver or copper, as ions or in elemental form. A biocidal effect has been produced, for example, with Si-coated TiO₂ particles.

DE 103 37 399 A1 describes a method for producing a silver colloid-containing substance and its inclusion in paints. Silver amine and diamine complexes with components based on epoxysilanes are included. The silver colloid particles have a diameter in the range of 5 nm to 30 nm, so that a controlled Ag release is achieved. The paints show a biocidal or bactericidal effect.

The bactericidal effect of silver is known, although the mechanism is not yet fully understood. Silver particles are physiologically tolerated. However, silver salts such as silver nitrate show only a slight antibacterial effect on zeolites. In addition, even with controlled release, silver particles leach out over time. Investigations by the inventor have shown that the antibacterial effect of silver-based systems falls off after only two weeks.

DE 696 23 328 concerns a composition which contains mannanase to prevent and/or remove biofilms on surfaces. DE 696 19 665 discloses an exopolysaccharide-decomposing enzyme which is able to break down colonic acid. However, these enzymatic processes are not preventative, but attack an existing biofilm.

### SUMMARY OF INVENTION

An object of the invention is to find an improved coating which significantly reduces or prevents biofilm formation, particularly in heat exchangers such as condenser tubes (of industrial turbines) and subsidiary cooling circuits, and a method for the manufacturing thereof. The coating is intended to

disrupt the attachment mechanism of the bacteria and thereby prevent or minimize attachment,

make it possible to dispense with the use of soluble biocide chemicals or toxic metals and therefore to design, for example, affected power stations to be more ecologically tolerable,

improve, or not restrict, the thermal conductivity of the coated material,

adhere well to the coated material and be resistant to hydrolysis,

enable a much lower maintenance cost for the plant compared with mechanical cleaning processes.

This object is achieved with a coating and a method as claimed in the independent claims. Advantageous embodiments and applications of the invention emerge from the dependent claims.

Surprisingly, the object could be achieved according to the invention in that the coating has the following combination of properties:

prevention, by hydrophobic surfaces, of the formation of a water film,

reduction of the surface energy by nanoparticles,

increasing the thermal and electrical conductivity with nano and/or microparticle composites,

hydrolysis-resistance through the use of hydrolysis-resistant polymers,

corrosion protection for pipelines.

The hydrophobic surface of the coating according to the invention prevents the formation of a water film. It is known that the formation of deposits can be suppressed by coating the relevant surfaces with a low-energy coating material. The surface energy determines the wettability (see FIG. 1). The contact angle or wetting angle θ of a liquid drop depends on the surface energy of the liquid σ₁ and of the substrate surface σₛ and is a measure of the energetic interaction between the solid body and the liquid. The energy of the interface between the liquid and the substrate surface is σₛ₁.

$$cos θ = \frac{{σ}_{s} - {σ}_{sl}}{{σ}_{l}} = \frac{{σ}_{c}}{{σ}_{l}}$$

A permanent water film on the surface would favor the attachment of bacteria. The coatings according to the invention produce superhydrophobic surfaces with surface energies of less than 20 mN/m, so that a permanent water film, and thus the attachment of bacteria, is lessened or avoided. In one embodiment, the surface energy is less than 15 mN/m. In another embodiment, the surface energy is less than 10 mN/m.

Thermally stable metal alkoxidic materials which are preferably producible with the sol-gel method are suitable as coating materials according to the invention. The sol-gel hybrid polymers are curable thermally and by UV radiation.

Sol-gel-based anti-adherence coatings have a network structure with organic and inorganic components.

Metal alkoxides with the following formula (I) are essentially used in the present invention.

Xₙ-M-(OR)ₘ₋ₙ (I)

where X is a branched or straight-chain C₁ to C₁₂ alkylsilyl group or a C₁ to C₁₂ arylsilyl group wherein the alkylsilyl group or the arylsilyl group is also substituted with one or more C₁ to C₁₂ alkoxy groups and/or Cᵢ to C₁₂ aryloxy groups. Suitable groups for X preferably include methyltrimethoxysilane, methyltriethoxysilane, tetraethoxyorthosilane, propyltrimethoxysilane, propyltriethoxysilane, isobutyltrimethoxysilane, isobutyltriethoxysilane, octyltriethoxysilane, hexadecyltrimethoxysilane, octadecyltrimethoxysilane, phenyltrimethoxysilane and phenyltriethoxysilane.

M can be an arbitrary metal or element having a plurality of groups Xₙ and (OR)ₘ₋ₙ. Preferably, M=Al, Si, Ti or Zr, or more preferably M=Si.

R is a branched or straight-chain C₁ to C₅ alkyl group or aryl group or a silyl group substituted therewith. R preferably comprises ethyl groups (tetraethyl titanate), isopropyl groups or trimethylsiloxide groups.

Values for m, n and n′ are given by the valency of the metal or element M and can be selected accordingly. It is a general principle that m and n are natural numbers ≧1 and n′=m−n. For example, m=4 for M=Si, Ti, Zr, m=3 for M=Al, n=1 to 3 for M=Si, Ti, Zr and n=1 to 3 for M=Al.

Further, according to the invention, coatings which comprise conventional hydrolysis-resistant paints are suitable. Preferably, a paint system is selected from the group including polyurethanes, acrylics and silicones.

In silicones, silicon atoms are linked via oxygen atoms to molecule chains and/or network structures. The remaining free valency electrons of the silicon are saturated through hydrocarbon groups, for example, by methyl groups as illustrated in formula (A).

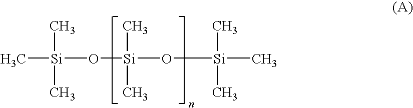

As silicones, above all cross-linked polymethylsiloxanes or polymethylphenylsiloxanes and fluorosilicones are suitable. Fluorosilicones are temperature-resistant and oxidation-resistant silicones wherein the methyl groups are replaced by fluoroalkyl groups. For example, one or two-component silicone rubbers such as Powersil 567 or Elastosil® 675 from the firm of Wacker Chemie AG are used. These silicones are heat-resistant, hydrophobic, dielectric and are usually regarded as being physiologically tolerated.

Coatings according to the present invention can be applied with conventional methods known to persons skilled in the art, such as dipping, flooding, spraying or spreading. The coating according to the invention preferably has a coating depth of more than 10 μm, preferably 30 μm to 150 μm, more preferably 50 μm to 100 μM, so that the surface roughness of the raw material is evened out. Due to the low layer thickness of the hydrophobic coating, the pressure loss in the pipe is not reduced. The layer thickness is in any event selected so that the roughness of the raw material can be evened out.

In one embodiment, by addition of microparticles and/or nanoparticles, at the same time as the surface functionalization, a defined stochastic microroughness is obtained in the coating with regard to the maximum occurring height difference between elevation and depression in the coating surface, which further improves the anti-hold properties with respect to bacteria. In one embodiment, the coating has a roughness (determined according to DIN 4762, ISO 4287/1) of less than 200 nm, preferably less than 150 nm and/or stochastic topographies with roughnesses of less than 500 nm, preferably less than 300 nm.

### BRIEF DESCRIPTION OF THE DRAWINGS

In the drawings:

FIG. 1 shows the contact angle or wetting angle θ of a liquid drop as a measure of the energetic interaction between the solid body and the liquid,

FIG. 2 shows the surface of a coating according to the invention in an enlargement of 3 μm, comprising a stochastic topography of 500 μm produced by microparticles. The roughness Ra is less than 500 nm,

FIG. 3 shows the surface of a coating according to the invention in an enlargement of 3 μm, which comprises a stochastic topography of 500 nm produced by microparticles. The roughness Ra is less than 500 nm,

FIG. 4 shows the smooth surface of a coating according to the invention in an enlargement of 3 μm, which does not contain any microparticles and has a roughness of less than 50 nm.

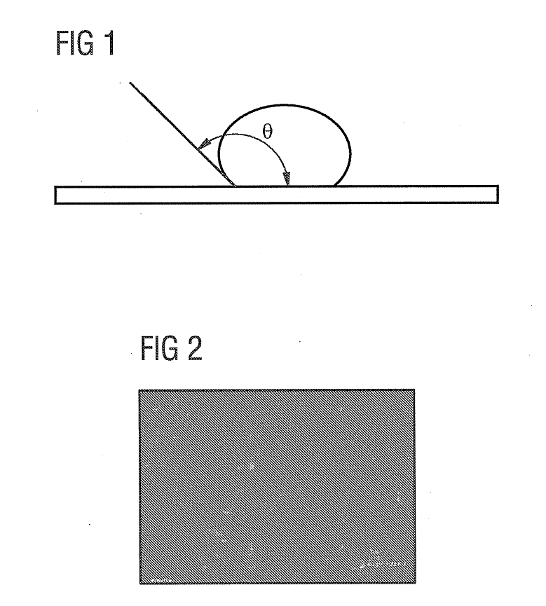

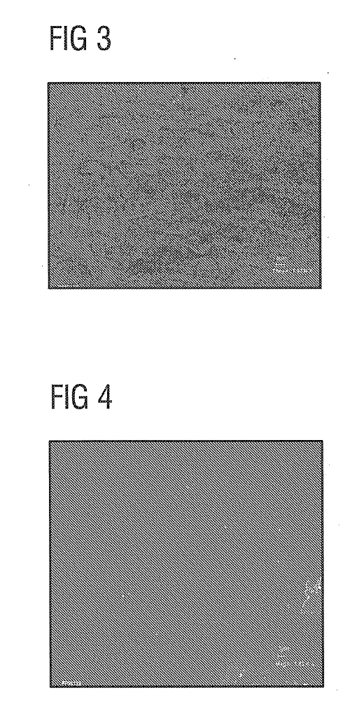

### DETAILED DESCRIPTION OF INVENTION

Suitable microparticles or nanoparticles which can be contained in the coating are, according to the invention, selected from the group consisting of SiO₂, Al₂O₃, SiC and BN. The particles have a size in the range of 0.5 μm to 5.5 μm, and preferably 0.5 μm to 2.0 μm. If smaller particle sizes are selected, the polymer system becomes viscous even with a content of 10%.

In one embodiment, the particles are SiO₂ particles, in particular fluorine-functionalized SiO₂ particles. In another embodiment, the particles are BN particles. According to the invention, the coating comprises particles in a quantity in the range of 10% to 35% by volume, preferably 25% to 32% by volume and more preferably 30% by volume. With volume proportions up to approximately 30%, the thermal conductivity of the composite is almost independent of the strengthening phase. The particles are then fully enclosed by the plastics layer. With filling levels of up to 30% by volume, smooth layers are still achieved.

The resulting contact angle (with respect to water) of commercially available PUR and silicone varnishes are in the range of 95° to 100°. With fluorine-functionalized SiO₂ particles or BN particles, the contact angle can be increased to 140°, so that the surface energy can be reduced to values of less than 15 mN/m.

By inclusion of heat-conducting particles with anti-adhesion properties, such as boron nitride particles, into the coating, the surface energy can be further reduced to values under 15 mN/m. Due to the very good thermal conductivity of boron nitride, the plate-shaped BN particles result in an improvement in thermal conduction. In addition, electrostatic charging can be prevented by means of anti-static silicone coatings with conducting particles.

In another embodiment, BN particles are included in the coating. Through the inclusion of electrically insulating BN particles having the above-mentioned dimensions, the coating according to the invention which has a significantly increased contact angle, also has raised thermal conductivity. The thermal conductivity depends on the size and morphology of the included particles. Possible morphologies are, for example, spherical, splintered or layered structures, but a plate-shaped morphology is preferable.

The cell-to-cell signaling at the surface of the bacteria through messenger substances usually brings about the attachment of further bacteria. By contrast, the cell-to-cell signaling of degraded proteins causes further suppression of the attachment of bacteria. In one embodiment, messenger substances which suppress the cell-to-cell signaling and thus the further attachment of bacteria in the long term are included in the coating. Suitable messenger substances include, for example, homoserine lactones (HSL), AHL and N-acyl-homoserine lactone for gram-negative microorganisms and posttranslationally modified peptides for gram-positive microorganisms. Messenger substances are described, by way of example, in Skiner et al., FEMS Microbiol. Rev. (2005) and include compounds such as 3-oxo-C6-HSL (Vibrio fisheri), 2-heptyl-3-hydroxyl-4-quinoline (Pseudomonas aeruginosa), Butyrolactone (Streptomyces griseus), cyclic thiolactone (type III) (Staphylococcus aureus), S-THMF-borate (V. harveyi) and R-THMF (S. typhimurium).

Manufacturing Method

A method for manufacturing the coating according to the invention comprises the following steps:

Preparation of a Metal-Alkoxide-Sol with an Organically Modified Metal Alkoxide of the General Formula I as the Starting Substance

Xₙ-M-(OR)ₘ₋ₙ (I),

where X is a branched or straight-chain C₁ to C₁₂ alkylsilyl group or a C₁ to C₁₂ arylsilyl group, wherein the alkylsilyl group or the arylsilyl group is also substituted with one or more C₁ to C₁₂ alkoxy and/or C₁ to C₁₂ aryloxy groups;
M is a metal or element;
R is a branched or straight-chain C₁ to C₅ alkyl group or aryl group or a silyl group substituted therewith;
m and n are natural numbers where m and n≧1 and n′=m−n;
or alternatively a paint system selected from hydrolysis-resistant paints of the group including polyurethanes, acrylics and silicones;
application of the sol or the paint system to at least one surface to be coated by dipping, flooding, spraying or spreading;
curing the metal alkoxide sol or paint system wherein the curing of the silicone, acrylic or PUR system is carried out at temperatures of between 15° C. and 50° C. and wherein the curing of the metal alkoxide sol is carried out by means of heat or UV radiation by hydrolysis and condensation of the metal alkoxides.

The groups X preferably comprise methyltrimethoxysilane, methyltriethoxysilane, tetraethoxyorthosilane, propyltrimethoxysilane, propyltriethoxysilane, isobutyltrimethoxysilane, isobutyltriethoxysilane, octyltriethoxysilane, hexadecyltrimethoxysilane, octadecyltrimethoxysilane, phenyltrimethoxysilane and phenyltriethoxysilane. Preferably also, M=Al, Si, Ti or Zr and more preferably M=Si. R preferably comprises ethyl groups (tetraethyl titanate), isopropyl groups or trimethylsiloxide groups.

The layer thickness of the coating according to the invention is in the range of 10 μm to 150 μm and preferably 50 μm to 130 μm and particularly preferably 50 μm to 100 μm.

In one embodiment, the at least one surface is a pipe inner surface.

In another embodiment, silicone which contains in the range of 10% to 30% by volume of boron nitride particles is used as the coating material.

The surface to be coated can be cleaned and de-greased with an organic solvent before application of the sol or the paint system. The surface to be coated can also be coated with a foundation layer and/or an adhesion promoter before application of the sol or the paint system. The surface to be coated can also be coated with a molecular layer containing silanes or siloxanes before application of the sol or the paint system.

If spraying is performed to coat the surface, this can be carried out using the Plastocor process wherein a telescopic structure with a spray nozzle is used to coat long cooling pipes having a relatively small pipe diameter.

The hydrophobic coating according to the invention has been tested for the biocidal effects thereof on stainless steel and titanium substrates. With coating thicknesses of approximately 100 μm on titanium tube substrates, contact angles relative to water in the range of 130° to 145° have been achieved.

The coating according to the invention has a high hydrolysis-resistance. The surface energies achieved are maintained, even during water storage over many months. For example, with BN-filled silicone coatings and ageing in river water, no colonization with bacteria occurs on the coated substrate even after 40 weeks.

With BN levels of approximately 30% by volume in the coating, thermal conductivities of greater than 3 W/mK were obtained.

The use of these biocidal materials in the cooling circuit can make the use of soluble biocides unnecessary. In an ideal case, a tube cleaning system can be dispensed with altogether. Further advantages are the maintenance of plant performance levels, longer plant lifetimes and reduced cleaning effort.

The invention will now be described in greater detail with the accompanying examples, but without limiting it thereto.

### Example 1

The inside of a steel pipe was treated with a commercially available adhesion promoter from the firm of Wacker Chemie AG and then sprayed with a silicone paint. The silicone paint had previously had 30% by volume of submicrocrystalline platelet-shaped BN particles, BN CTP05, from the firm of Saint-Gobain mixed into it. Following application, the paint was cured at approximately 30° C.

### Example 2

Using the Plastocor method, a polyurethane paint with 20% by volume of fluorine-functionalized SiO₂ particles was applied to the inside of a de-greased titanium pipe. Following application, the paint was cured at 20° C.

1.-28. (canceled)

29. A coating for containers and pipes for reducing or preventing biofilm formation, comprising:
a surface energy of less than 20 mN/m,
wherein thermally stable metal alkoxide materials or hydrolysis-resistant paints are used as coating materials, the hydrolysis-resistant paints being selected from the group consisting of polyurethanes, acrylics and silicones, and
wherein at least one organically modified metal alkoxide of the general formula (I) is used as a starting material for the thermally stable metal alkoxide material
Xₙ-M-(OR)ₘ₋ₙ (I),
wherein X is a branched or straight-chain C₁- to C₁₂-alkylsilyl group or a C₁- to C₁₂-arylsilyl group, the alkylsilyl group or the arylsilyl group being substituted with one or more C₁- to C₁₂-alkoxy and/or C₁- to C₁₂-aryloxy groups,
wherein M is a metal or element,
wherein R is a branched or straight-chain C₁- to C₅-alkyl group or aryl group or a silyl group substituted therewith, and
wherein m and n are natural numbers where m or n≧1 and n′=m−n.

30. The coating as claimed in claim 29, wherein X is selected from the group consisting of methyltrimethoxysilane, methyltriethoxysilane, tetraethoxyorthosilane, propyltrimethoxysilane, propyltriethoxysilane, isobutyltrimethoxysilane, isobutyltriethoxysilane, octyltriethoxysilane, hexadecyltrimethoxysilane, octadecyltrimethoxysilane, phenyltrimethoxysilane and phenyltriethoxysilane.

31. The coating as claimed in claim 29, wherein M is selected from the group consisting of Al, Si, Ti and Zr.

32. The coating as claimed in claim 29, wherein R is selected from the group consisting of ethyl, isopropyl and trimethylsiloxide.

33. The coating as claimed in claim 29, wherein a thickness of the coating is in the range of 10 μm to 150 μm.

34. The coating as claimed in claim 29, wherein the coating comprises microparticles or nanoparticles selected from the group consisting of SiO₂, Al₂O₃, SiC and BN, wherein a particle size is in the range of 0.5 μm to 5.5 μm.

35. The coating as claimed in claim 34, wherein the particles are present in the coating in a quantity in the range of 10% to 35% by volume.

36. The coating as claimed in claim 29, wherein the coating comprises electrically conductive particles.

37. The coating as claimed in claim 29, wherein the silicone is selected from the group consisting of polymethylsiloxanes, polymethylphenylsiloxanes and fluorosilicones.

38. The coating as claimed in claim 29, wherein a roughness of the coating is less than 200 nm.

39. The coating as claimed in claim 29, wherein the coating comprises stochastic topographies with a roughness of less than 500 nm.

40. The coating as claimed in claim 29, wherein the coating comprises explicit messenger substances for the suppression of cell-to-cell signaling.

41. A method for manufacturing a coating for containers and pipes for reducing or preventing biofilm formation, comprising:
providing a metal alkoxide sol with an organically modified metal alkoxide of the general formula (I) as a starting material
Xₙ-M-(OR)ₘ₋ₙ (I),
wherein X is a branched or straight-chain C₁- to C₁₂-alkylsilyl group or a C₁- to C₁₂-arylsilyl group, the alkylsilyl group or the arylsilyl group being substituted with one or more C₁- to C₁₂-alkoxy and/or C₁- to C₁₂-aryloxy groups,
wherein M is a metal or element,
wherein R is a branched or straight-chain C₁- to C₅-alkyl group or aryl group or a silyl group substituted therewith, and
m and n are natural numbers where m and n≧1 and n′=m−n;
applying the sol to at least one surface to be coated by dipping, flooding, spraying or spreading; and
curing the metal alkoxide sol,
wherein the curing of the metal alkoxide sol is carried out by means of heat or UV radiation by hydrolysis and condensation of the metal alkoxides.

42. The method as claimed in claim 41, further comprising:
cleaning and de-greasing the at least one surface to be coated with an organic solvent before applying the sol.

43. The method as claimed in claim 41, further comprising:
coating the at least one surface to be coated with a foundation layer and/or an adhesion promoter before applying the sol.

44. The method as claimed in claim 41, further comprising:
coating the at least one surface to be coated with a molecular layer comprising silanes or siloxanes before applying the sol.

45. A method for manufacturing a coating for containers and pipes for reducing or preventing biofilm formation, comprising:
providing a paint system comprising of hydrolysis-resistant paints selected from the group consisting of polyurethanes, acrylics and silicones;
applying the paint system to at least one surface to be coated by dipping, flooding, spraying or spreading; and
curing the paint system,
wherein the curing of the silicone, acrylic or PUR system is carried out at temperatures in the range of 15° C. and 50° C.

46. The method as claimed in claim 45, further comprising:
cleaning and de-greasing the at least one surface to be coated with an organic solvent before applying the paint system.

47. The method as claimed in claim 45, further comprising:
coating the at least one surface to be coated with a foundation layer and/or an adhesion promoter before applying the paint system.

48. The method as claimed in claim 45, further comprising:
coating the at least one surface to be coated with a molecular layer comprising silanes or siloxanes before applying the paint system.
